(19) United States
(12) Patent Application Publication
(10) Pub. No.: US 2026/0221842 A1
(43) Pub. Date: Jul. 30, 2026

(54) DRIVE SYSTEM AND ELECTRIC SYSTEM

(71) Applicant: HONDA MOTOR CO., LTD., Tokyo (JP)

(72) Inventors: Naoki KAMIMURA, Saitama (JP); Satoshi YAMADA, Saitama (JP); Tatsunoshin ISHIKAWA, Saitama (JP)

(21) Appl. No.: 19/352,623

(22) Filed: Oct. 8, 2025

(30) Foreign Application Priority Data
Dec. 26, 2024 (JP) 2024-230795

(51) Int. Cl. H02K 9/06; B64C 29/02; H02K 7/00; H02K 9/22

(52) U.S. Cl. CPC H02K 9/06; B64C 29/02; H02K 7/003; H02K 7/006; H02K 9/22

(57) ABSTRACT

A drive system includes a first drive unit, a second drive unit, and a fan, which are arranged in a row along a first direction. The first drive unit includes a first cooling passage communicating with a first inlet and a first outlet, and extending along the first direction. The second drive unit includes a second cooling passage communicating with a second inlet and a second outlet, and extending along the first direction. The fan sucks in a refrigerant flowing out from the first outlet and blow the refrigerant in a direction intersecting the first direction, thereby causing the refrigerant to flow through the first cooling passage, and suck in the refrigerant in the direction intersecting the first direction and blow the refrigerant toward the second inlet, thereby causing the refrigerant to flow through the second cooling passage.

### TECHNICAL FIELD

The present invention relates to a drive system including a first drive unit, a second drive unit, and a fan

### BACKGROUND ART

In recent years, efforts to realize a low-carbon or carbon-free society have been gaining momentum, and research and development of electrification technologies is being conducted for vehicles, aircraft, and the like to reduce CO2 emissions and improve energy efficiency.

A technology for cooling two units using an airflow generated by a fan is conventionally known. In such technology, in a case where the air heated by cooling one unit flows into the other unit, the other unit may not be cooled sufficiently. In view of this, a technology for cooling two units while preventing the air heated by cooling one unit from flowing into the other unit is known.

For example, FIG. 30 of JP2024-4442A shows a propulsion device including a motor that rotates a propeller to propel an aircraft, an inverter that supplies power to the motor, and an intermediate fan arranged between the motor and the inverter. Each of the motor and the inverter is a single unit. The propeller, the motor, the intermediate fan, and the inverter are arranged in a row along a rotational axis direction of the motor.

In the propulsion device shown in FIG. 30 of JP2024-4442A, a cooling passage extending in the rotational axis direction of the motor is provided inside a casing of the motor (a motor casing) and inside a casing of the inverter (an inverter casing). The intermediate fan arranged between the motor and the inverter blows the air flowing out from the cooling passage of the motor and the air flowing out from the cooling passage of the inverter radially outward of the rotational axis of the motor. This generates an outer co-flow (a cooling airflow that flows along the slipstream generated by the rotation of the propeller) flowing through the cooling passage of the motor, and the outer co-flow cools the motor. An outer counter-flow (a cooling airflow that flows in the direction opposite to the slipstream) flowing through the cooling passage of the inverter is generated, and the outer counter-flow cools the inverter. Moreover, the outer co-flow flowing out from the motor flows in a radially outward direction of the rotational axis of the motor, and does not flow into the cooling passage of the inverter. The outer counter-flow flowing out from the inverter flows in the radially outward direction of the rotational axis of the motor, and does not flow into the cooling passage of the motor.

In electrification technology, efficient cooling is a challenge. In the propulsion device described in JP2024-4442A, in the outer co-flow, the direction of the slipstream generated by the rotation of the propeller is the same as the direction of the airflow flowing into the cooling passage of the motor. In the outer counter-flow, the direction of the airflow flowing into the cooling passage of the inverter is opposite to the direction of the slipstream. Accordingly, the velocity of air flowing into the cooling passage of the inverter is decreased due to the slipstream. The amount of air flowing into the cooling passage of the inverter (the flow rate of a first outer counter-flow) decreases, and the efficiency of cooling the inverter decreases. Accordingly, the inverter may not be sufficiently cooled.

### SUMMARY OF THE INVENTION

In view of the above background, an object of the present invention is to efficiently cool a first drive unit and a second drive unit in a drive system having the first drive unit and the second drive unit. This contributes to improving the energy efficiency.

To achieve such an object, one aspect of the present invention provides a drive system (16) including a first drive unit (31), a second drive unit (32), and a fan (33). The first drive unit, the fan, and the second drive unit are arranged in this order and in a row along a first direction (X) from the first drive unit to the second drive unit. The first drive unit includes a first cooling passage (P1) extending along the first direction and having a first inlet (P1A) formed on a side opposite to the fan and a first outlet (P1B) formed on a side of the fan. The second drive unit includes a second cooling passage (P2) extending along the first direction and having a second inlet (P2A) formed on the side of the fan and a second outlet (P2B) formed on the side opposite to the fan. The fan is configured to suck in a refrigerant (air) flowing out from the first outlet and blow the refrigerant in a direction intersecting the first direction, thereby causing the refrigerant to flow through the first cooling passage, and suck in the refrigerant in the direction intersecting the first direction and blow the refrigerant toward the second inlet, thereby causing the refrigerant to flow through the second cooling passage.

According to this aspect, the fan blows the refrigerant flowing out from the first outlet in a direction intersecting the first direction. This prevents the refrigerant flowing out from the first outlet from flowing into the second cooling passage from the second inlet. Accordingly, it is possible to prevent the refrigerant heated in the first cooling passage and flowing out from the first outlet from flowing into the second cooling passage from the second outlet, thereby preventing a decrease in the cooling efficiency of the second drive unit. Further, the refrigerant flowing out from the second outlet flows away from the first inlet. Accordingly, it is possible to prevent the refrigerant heated in the second cooling passage and flowing out from the second outlet from flowing into the first cooling passage from the first inlet, thereby preventing a decrease in the cooling efficiency of the first drive unit. Accordingly, in the drive system including the first drive unit and the second drive unit, the first drive unit and the second drive unit can be efficiently cooled.

In the above aspect, preferably, the fan includes a hub (61), a plurality of first blades (62) configured to suck in the refrigerant from the first outlet and blow the refrigerant in the direction intersecting the first direction, and a plurality of second blades (63) configured to suck in the refrigerant in the direction intersecting the first direction and blow the refrigerant toward the second inlet, the hub, the plurality of first blades, and the plurality of second blades being integrally formed with each other.

According to this aspect, the fan can cause the refrigerant to flow through the first cooling passage and the second cooling passage simply by rotating the hub around the first direction. This makes it easier to cool the first drive unit and the second drive unit by the refrigerant.

In the above aspect, preferably, the drive system further includes a separation wall (71) one end of which is arranged to cover an outer circumference of a boundary between the plurality of first blades and the plurality of second blades, the separation wall extending radially outward relative to the hub from the one end and configured to separate the refrigerant blown by the plurality of first blades in the direction intersecting the first direction from the refrigerant sucked in by the plurality of second blades in the direction intersecting the first direction.

According to this aspect, the separation wall separates the refrigerant blown by the first blades and flowing out from the first outlet from the refrigerant sucked in by the second blades and flowing into the second inlet. This more reliably prevents the refrigerant heated in the first cooling passage and flowing out from the first outlet from flowing into the second cooling passage from the second inlet, thereby preventing a decrease in the cooling efficiency of the second drive unit.

In the above aspect, preferably, the drive system includes a separation duct (72) formed integrally with the separation wall, extending from a radially outer end of the separation wall along the first direction, and covering an outer circumference of the second drive unit.

According to this aspect, the separation duct separates the refrigerant blown by the first blades and flowing out from the first outlet from the refrigerant sucked in by the second blades and flowing into the second inlet. This more reliably prevents the refrigerant heated in the first cooling passage and flowing out from the first outlet from flowing into the second cooling passage from the second inlet, thereby preventing a decrease in the cooling efficiency of the second drive unit.

In the above aspect, preferably, the separation wall is formed integrally with the hub.

According to this aspect, the separation wall is formed integrally with the hub, so that the separation wall can be easily provided.

In the above aspect, preferably, the second drive unit includes a duct (42) that defines the second cooling passage, the one end of the separation wall is close to but spaced from the outer circumference of the boundary between the plurality of first blades and the plurality of second blades, and the separation duct is coupled to the duct.

According to this aspect, because the separation wall and the hub are not integrally formed, in a case where the hub rotates, the separation wall does not rotate around the first direction. Accordingly, the drive system does not consume power to rotate the separation wall, and the power consumption of the drive system can be reduced more than in a case where the separation wall and the hub are integrally formed.

In the above aspect, preferably, the drive system includes a shaft (35) supported by the first drive unit and the second drive unit to be rotatable around the first direction, coupled to the hub, and extending along the first direction, and a propeller (36) fixed to the shaft. The first drive unit and the second drive unit are configured to rotate the shaft around the first direction to generate a propulsive stream flowing along the first direction from the propeller, the hub is configured to rotate around the first direction with the shaft, and the propeller is arranged at a first end of the shaft on a side of the second drive unit.

According to this aspect, as the propeller rotates, the propulsive stream flowing along the first direction is generated. Thus, a portion of the propulsive stream easily flows into the first cooling passage from the first inlet. Further, the refrigerant that has flowed through the second cooling passage flows along the first direction from the second outlet together with the propulsive stream. Accordingly, the refrigerant that has flowed through the second cooling passage easily flows out from the second outlet. This prevents the flow rate of the refrigerant flowing through the first cooling passage from being decreased due to the propulsive stream, and also prevents the flow rate of the refrigerant flowing through the second cooling passage from being decreased due to the propulsive stream. Accordingly, the drive system can efficiently cool the first drive unit and the second drive unit.

In the above aspect, preferably, the drive system includes a shaft (35) supported by the first drive unit and the second drive unit to be rotatable around the first direction, coupled to the hub, and extending along the first direction, and a propeller (36) fixed to the shaft. The first drive unit and the second drive unit are configured to rotate the shaft around the first direction to generate a propulsive stream flowing along the first direction from the propeller, the hub is configured to rotate around the first direction with the shaft, and the propeller is arranged at a second end of the shaft on a side of the first drive unit.

According to this aspect, as the propeller rotates, the propulsive stream flowing along the first direction is generated. Thus, a portion of the propulsive stream easily flows into the first cooling passage from the first inlet. Further, the refrigerant that has flowed through the second cooling passage flows from the second outlet along the first direction together with the propulsive stream. Accordingly, the refrigerant that has flowed through the second cooling passage easily flows out from the second outlet. This prevents the flow rate of the refrigerant flowing through the first cooling passage from being decreased due to the propulsive stream, and also prevents the flow rate of the refrigerant flowing through the second cooling passage P2 from being decreased due to the propulsive stream. Accordingly, the drive system can efficiently cool the first drive unit and the second drive unit.

To achieve such an object, one aspect of the present invention provides an electric system (16) including a first electric device (31), a second electric device (32), and a fan (33), and the first electric device, the fan, and the second electric device are arranged in this order and in a row along a first direction (X) from the first electric device to the second electric device, the first electric device includes a first cooling passage (P1) extending along the first direction and having a first inlet (P1A) formed on a side opposite to the fan and a first outlet (P1B) formed on a side of the fan, the second electric device includes a second cooling passage (P2) extending along the first direction and having a second inlet (P2A) formed on the side of the fan and a second outlet (P2B) formed on the side opposite to the fan, and the fan is configured to suck in a refrigerant (air) flowing out from the first outlet and blow the refrigerant in a direction intersecting the first direction, thereby causing the refrigerant to flow through the first cooling passage, and suck in the refrigerant in the direction intersecting the first direction and blow the refrigerant toward the second inlet, thereby causing the refrigerant to flow through the second cooling passage.

According to this aspect, the fan blows the refrigerant flowing out from the first outlet in a direction intersecting the first direction, so that the refrigerant flowing out from the first outlet is prevented from flowing into the second cooling passage from the second outlet. Accordingly, it is possible to prevent the refrigerant heated in the first cooling passage and flowing out from the first outlet from flowing into the second cooling passage from the second outlet, thereby preventing a decrease in the cooling efficiency of the second electric device. Further, the refrigerant flowing out from the second outlet flows away from the first inlet. Accordingly, it is possible to prevent the refrigerant heated in the second cooling passage and flowing out from the second outlet from flowing into the first cooling passage from the first outlet, thereby preventing a decrease in the cooling efficiency of the first drive unit. Therefore, in the electric system including the first electric device and the second electric device, the first electric device and the second electric device can be efficiently cooled.

Thus, according to the above aspects, it is possible to efficiently cool the first drive unit and the second drive unit in the drive system including the first drive unit and the second drive unit.

### BRIEF DESCRIPTION OF THE DRAWING(S)

FIG. 1 is a perspective view showing an aircraft according to a first embodiment;

FIG. 2 is a schematic cross-sectional view of a propulsion unit;

FIG. 3 is a perspective view of a drive system;

FIG. 4 is a cross-sectional view of an outer circumference of a first drive unit, a fan, and a second drive unit;

FIG. 5 is a cross-sectional view of a main part of the second drive unit and a separation plate;

FIG. 6 is a schematic cross-sectional view of the drive system;

FIG. 7 is a perspective view of a drive system according to a second embodiment;

FIG. 8 is a cross-sectional view of an outer circumference of the first drive unit, the fan, and the second drive unit;

FIG. 9 is a schematic cross-sectional view of the drive system;

FIG. 10 is a schematic cross-sectional view of a drive system according to a first modification; and

FIG. 11 is a schematic cross-sectional view of a drive system according to a second modification.

### DETAILED DESCRIPTION OF THE INVENTION

### First embodiment

### An aircraft 1

In the following, an aircraft 1 according to a first embodiment of the present invention will be described with reference to the drawings. In the drawings and the following description, forward, rearward, left, right, up and down are directions defined relative to the aircraft 1.

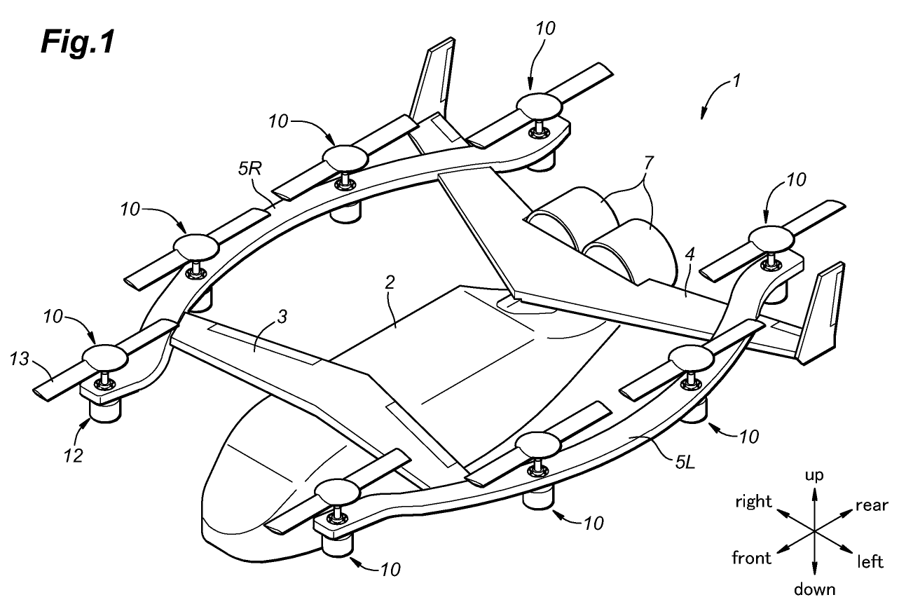

FIG. 1 is a perspective view showing the aircraft 1 according to the first embodiment. The aircraft 1 is an electric vertical take-off and landing aircraft (eVTOL aircraft) capable of taking off and landing vertically. The aircraft 1 includes a body 2 extending in the front-and-rear direction, a front wing 3 extending in the lateral direction and connected to the front portion of the body 2, a rear wing 4 extending in the lateral direction and connected to the rear portion of the body 2, a left arm 5L extending in the front-and-rear direction and connecting the left end of the front wing 3 to the left side portion of the rear wing 4, and a right arm 5R extending in the front-and-rear direction and connecting the right end of the front wing 3 to the right side portion of the rear wing 4.

A cabin (not shown) for an occupant to board is provided in the front portion of the body 2. Left and right propulsion units 7 (which will be described later) for applying the forward propulsion force to the aircraft 1 are provided at the rear end of the body 2.

The left arm 5L and the right arm 5R are each provided with a plurality of (for example, four) lift units 10 for applying the ascending and descending forces to the aircraft 1. The plurality of lift units 10 is arranged at intervals in the front-and-rear direction. Each lift unit 10 includes a lift drive device 12 and a lift rotor 13 attached to the lift drive device 12. The lift drive device 12 includes an electric motor (not shown), and is configured to rotate the lift rotor 13 by the driving force of the electric motor.

### the propulsion unit 7

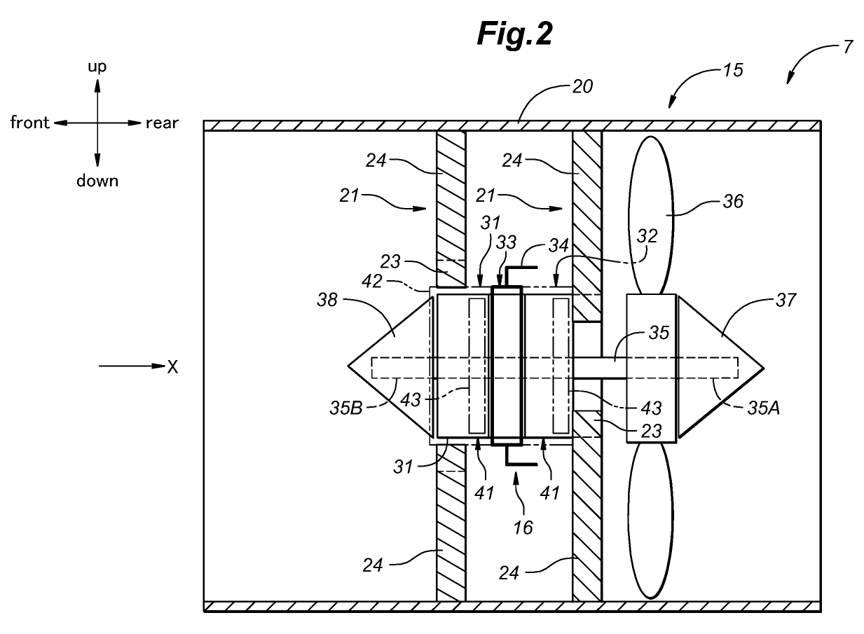

FIG. 2 is a schematic cross-sectional view of the propulsion units 7. Each propulsion unit 7 includes a support body 15 and a drive system 16 supported by the support body 15.

The support body 15 is fixed to the rear end of the body 2 (see FIG. 1). The support body 15 includes a cylindrical nacelle 20 extending in the front-and-rear direction, and front and rear mount frames 21 fixed to the inner circumferential surface of the nacelle 20. Each mount frame 21 includes an annular hub 23 that is concentric with the nacelle 20, and a plurality of spokes 24 extending radially from the outer circumferential surface of the hub 23 and connected to the inner circumferential surface of the nacelle 20.

### The drive system 16

As shown in FIG. 2, the drive system 16 includes a first drive unit 31, a second drive unit 32, a fan 33, a separation plate 34, a shaft 35 extending in the front-and-rear direction and rotatably supported by the drive system 16, and a propeller 36 fixed to the rear portion of the shaft 35. The drive system 16 is accommodated in the nacelle 20. The drive system 16 is fixed to the hubs 23 of the front and rear mount frames 21.

A direction from the first drive unit 31 to the second drive unit 32 is defined as a first direction X. The first drive unit 31, the fan 33 and the second drive unit 32 are arranged in a row along the first direction X in this order. The first drive unit 31 is fixed to the hub 23 of the front mount frame 21. The second drive unit 32 is fixed to the hub 23 of the rear mount frame 21. The drive system 16 is an example of an electric system. The first drive unit 31 is an example of a first electric device. The second drive unit 32 is an example of a second electric device. The first electric device and the second electric device consume electricity. The electric system is a system that includes the first electric device, the second electric device, and the fan.

The shaft 35 extends along the first direction X. A conical rear cover 37 whose diameter increases toward the front is fixed to a first end (the rear end) 35A of the shaft 35 on the side of the second drive unit 32. The rear cover 37 is arranged rearward of the center portion of the propeller 36. A conical front cover 38 whose diameter increases toward the rear is fixed to a second end (the front end) 35B of the shaft 35 on the side of the first drive unit 31.

The propeller 36 is configured to rotate integrally with the shaft 35 according to the rotation of the shaft 35, thereby generating the propulsive stream flowing along the first direction X. The propeller 36 generates the propulsive stream, thereby applying the forward propulsion force to the aircraft 1.

Each of the first drive unit 31 and the second drive unit 32 includes an electric motor 41 and a duct 42 that covers the outer circumference of the electric motor 41. The electric motor 41 includes a controller 43 that controls the driving of the electric motor 41. The controller 43 includes an inverter (not shown). The inverter becomes relatively hot. The electric motor 41 rotatably supports the shaft 35 about the axis, and rotates the shaft 35. The first drive unit 31 and the second drive unit 32 are units that include the electric motor 41 that rotates the shaft 35. The first drive unit 31 and the second drive unit 32 may be any unit related to the electric motor.

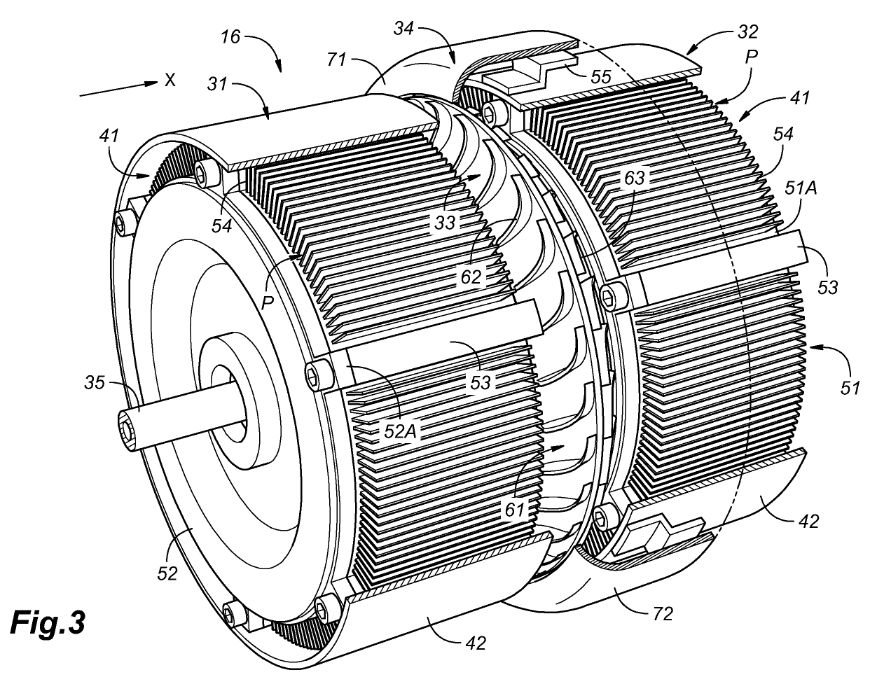

FIG. 3 is a perspective view of the drive system 16. In FIG. 3, the propeller 36 and the like are omitted. In the first drive unit 31 and the second drive unit 32, the electric motor 41 is formed in a cylindrical shape extending in the front-and-rear direction on the outer circumference of the shaft 35, and the duct 42 is formed in a cylindrical shape covering the outer circumference of the electric motor 41.

The electric motor 41 is an inner rotor type three-phase AC motor. The electric motor 41 includes a housing 51 that houses a rotor, a stator, and the controller 43, and a pair of front and rear lids 52 attached to the front and rear of the housing 51.

The housing 51 is formed in a cylindrical shape extending in the front-and-rear direction around the outer circumference of the shaft 35. The stator is fixed to the inside of the housing 51 and is formed in a cylindrical shape. The rotor is arranged inside the stator and facing the stator with a gap therebetween, and is formed integrally with the shaft 35. The stator includes a plurality of coils (not shown), and the rotor includes a plurality of permanent magnets (not shown) fixed to the outer circumference of the rotor. The magnetic force of the plurality of coils in the stator and the magnetic force of the permanent magnets in the rotor cause the rotor to rotate with the shaft 35.

An outer circumferential surface 51A of the housing 51 is provided with a plurality of fastening protrusions 53 that protrude radially outward at intervals in the circumferential direction of the housing 51, and a plurality of cooling fins 54 that are provided between adjacent fastening protrusions 53. The fastening protrusions 53 and the cooling fins 54 are formed integrally with the housing 51.

Each fastening protrusion 53 extends continuously along the first direction X from the front end to the rear end of the housing 51 and is formed in a rod shape having a rectangular cross section. Each cooling fin 54 extends continuously along the first direction X from the front end to the rear end of the housing 51, and is formed in a plate shape that protrudes upward. That is, each fastening protrusion 53 and the cooling fin 54 extends in parallel along the first direction X. Each fastening protrusion 53 protrudes radially outward from the housing 51 farther than each cooling fin 54. The duct 42 is attached to the radially outer end of the fastening protrusions 53. As will be described later, a support member 55 coupled to the separation plate 34 is fixed to the front end of each fastening protrusion 53 of the second drive unit 32 together with the duct 42.

Between the outer circumferential surface 51A of the housing 51 and the duct 42, a cooling passage P extending continuously along the front-and-rear direction from the front end to the rear end of the housing 51 is formed.

A pair of front and rear lids 52 are arranged at the front and rear of the housing 51 and close the front and rear openings of the housing 51. The lid 52 is formed in a disk shape and includes a fastening portion 52A on the outer circumference which corresponds to the front and rear end surfaces of each fastening protrusion 53. Each fastening portion 52A is fastened to the end surface (the front end surface or the rear end surface) of the corresponding fastening protrusions 53 with a bolt. Each fastening portion 52A of the lid 52 may be coupled to each fastening protrusion 53 by rivet, adhesive bonding, welding, or a combination thereof.

The fan 33 includes a hub 61 which includes a disk portion extending in a radial direction of the housing 51, a plurality of first blades 62 which protrudes from the front side surface (the surface on the side of the first drive unit 31) of the hub 61, and a plurality of second blades 63 which protrudes from the front side surface (the surface on the side of the second drive unit 32) of the hub 61. The hub 61, the plurality of first blades 62, and the plurality of second blades 63 are formed integrally with each other.

The hub 61 is coupled to the shaft 35. This causes the hub 61 to rotate with the shaft 35. As the hub 61 rotates, the first blades 62 blow air in the radially outward direction (a direction intersecting the first direction X), and the second blades 63 suck in air in the radially inward direction (a direction intersecting the first direction X). Here, the fan 33 is arranged between the first drive unit 31 and the second drive unit 32, and the fan is not arranged at the end of the drive system 16 in the front-and-rear direction. Accordingly, it is possible to prevent foreign objects (for example, birds) moving toward the fan 33 from the front or rear of the drive system 16 from coming into contact with the fan 33 and damaging the fan 33.

The separation plate 34 includes a separation wall 71 and a separation duct 72 which are formed integrally with each other. The separation wall 71 is formed in an annular shape extending around the outer circumference of the hub 61. The separation wall 71 has a radially inner end (one end) arranged to cover the outer circumference of the boundary between the first blades 62 and the second blades 63, and extends radially outward relative to the hub 61 from the inner end. The separation duct 72 is formed in a cylindrical shape that covers the outer circumference (the duct 42) of the second drive unit 32.

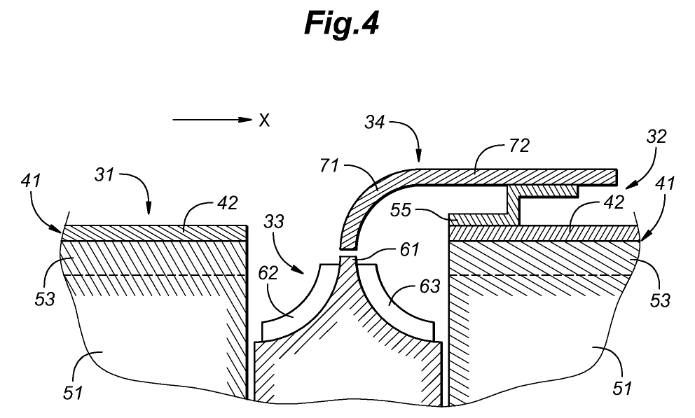

FIG. 4 is a cross-sectional view of the outer circumference of the first drive unit 31, the fan 33, and the second drive unit 32. The inner end of the separation wall 71 is close to but spaced from the outer circumference of the boundary between the first blades 62 and the second blades 63. The separation duct 72 is formed integrally with the separation wall 71 and extends along the first direction X from the radially outer end of the separation wall 71. As shown in FIG. 4, the separation duct 72 is coupled to the support member 55. The support member 55 is fixed to the front end of the fastening protrusions 53 with the duct 42 by bolts (not shown). Accordingly, the separation duct 72 is attached to the duct 42 via the support member 55. The separation duct 72 and the support member 55 may be coupled by rivets, fastening with bolts and nuts, adhesive bonding, welding, or a combination thereof

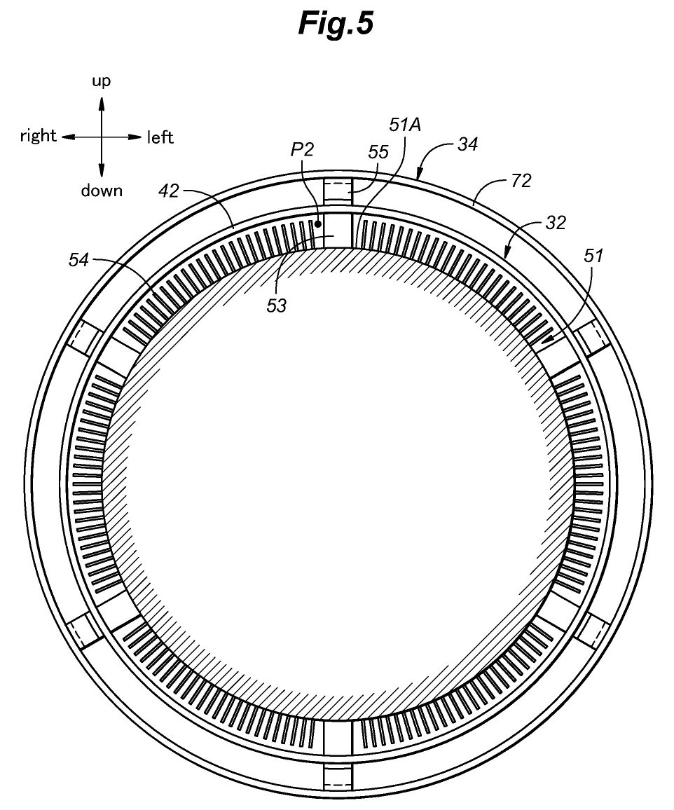

FIG. 5 is a cross-sectional view of a main part of the second drive unit 32 and the separation duct 72. As shown in FIG. 5, the separation duct 72 is supported via the support members 55 by the plurality of fastening protrusions 53 that are arranged at intervals in the circumferential direction of the housing 51. Accordingly, the radial distance between the separation duct 72 and the housing 51 is maintained at the prescribed distance over the entire circumference.

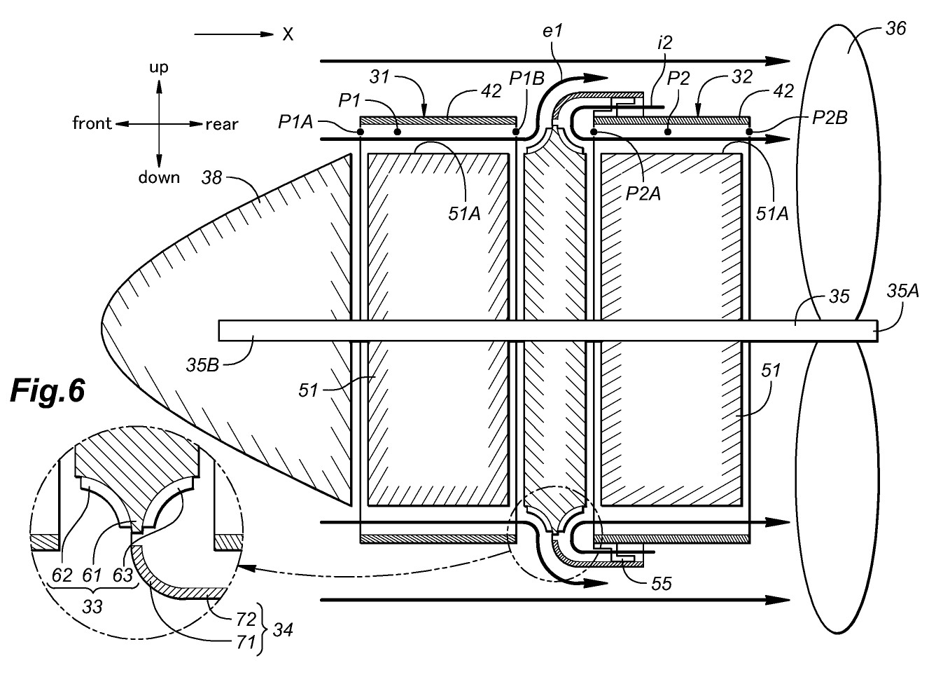

Next, the cooling of the drive system 16 will be described. FIG. 6 is a schematic cross-sectional view of the drive system 16. In FIG. 6, the rear cover 37 and the like are omitted. The cooling passage P of the first drive unit 31 is referred to as “first cooling passage P1.” The cooling passage P of the second drive unit 32 is referred to as “second cooling passage P2.”

The outer circumferential surface 51A of the housing 51 of the first drive unit 31 and the duct 42 define the first cooling passage P1. The first drive unit 31 includes a first inlet P1A formed on the side opposite to the fan 33 (front side), a first outlet P1B formed on the side of the fan 33 (rear side), and the first cooling passage P1 extending along the first direction X. The outer circumferential surface 51A of the housing 51 of the second drive unit 32 and the duct 42 define the second cooling passage P2. The second drive unit 32 includes a second inlet P2A formed on the side of the fan 33 (front side), a second outlet P2B formed on the side opposite to the fan 33 (rear side), and the second cooling passage P2 extending along the first direction X.

The first drive unit 31 and the second drive unit 32 rotate the shaft 35 around the first direction X. As the shaft 35 rotates, the fan 33 and the propeller 36 rotate. As the fan 33 rotates, the first blades 62 suck in air from the first outlet P1B and blow the air radially outward, and the second blades 63 suck in air in radially inward and blow the air toward the second inlet P2A. The first blades 62 suck in air from the first outlet P1B, so that the air flows through the first cooling passage P1, and the first drive unit 31 is cooled. Further, the second blades 63 blow air toward the second inlet P2A, so that the air flows through the second cooling passage P2, and the second drive unit 32 is cooled.

The air heated by flowing through the first cooling passage P1 (hereinafter referred to as "first exhaust air e1") is blown radially outward by a plurality of first blades 62. The first exhaust air e1 flows along the outer circumference of the separation wall 71, and further flows along the outer circumference of the separation duct 72. As the first exhaust air e1 flows along the outer circumference of the separation wall 71 and the separation duct 72, the first exhaust air e1 is diffused.

Further, as the shaft 35 rotates around the first direction X, the propulsive stream flowing along the first direction X is generated by the propeller 36. The flow direction of the air flowing into the first inlet P1A is the same as the flow direction of the propulsive stream (the first direction X). Accordingly, a portion of the propulsive stream flows into the first inlet P1A, so that air easily flows into the first inlet P1A. Further, since the flow direction of the air flowing through the first cooling passage P1 is the same as the flow direction of the propulsive stream (the first direction X), the air that has flowed through the first cooling passage P1 is easily discharged from the first outlet P1B. Accordingly, the amount of air flowing through the first cooling passage P1 is increased by the propulsive stream. The amount of air flowing through the first cooling passage P1 increases as the propulsive stream becomes stronger. This allows the first drive unit 31 to be cooled efficiently.

The air sucked in radially inward by the plurality of second blades 63 (hereinafter referred to as "second intake air i2") flows into the second cooling passage P2 from the second inlet P2A. The second intake air i2 is the air that flows between the duct 42 and the separation duct 72 of the second drive unit 32 and is sucked in by the plurality of second blades 63. The air flowing between the duct 42 and the separation duct 72 of the second drive unit 32 (the second intake air i2) is separated from the first exhaust air e1 by the separation plate 34.

The flow direction of the air flowing through the second cooling passage P2 and the flow direction of the air flowing out from the second outlet P2B are the same as the flow direction of the propulsive stream (the first direction X). Accordingly, the air that has flowed through the second cooling passage P2 is easily discharged from the second outlet P2B. This makes it easier for the second intake air i2 to flow into the second cooling passage P2. Accordingly, a sufficient amount of air flows through the second cooling passage P2, and the second drive unit 32 is efficiently and appropriately cooled.

Next, the effects of the drive system 16 will be described.

The fan 33 sucks in the air flowing out from the first outlet P1B and blows the air radially outward, thereby causing the air to flow through the first cooling passage P1. The fan 33 sucks in air radially inward and blows the air toward the second inlet P2A, thereby causing the air to flow through the second cooling passage P2. The fan 33 blows the air flowing out from the first outlet P1B radially outward. This prevents the air flowing out from the first outlet P1B from flowing into the second cooling passage P2 from the second inlet P2A. Accordingly, it is possible to prevent the air heated in the first cooling passage P1 and flowing out from the first outlet P1B from flowing into the second cooling passage P2 from the second outlet P2B, thereby preventing a decrease in the cooling efficiency of the second drive unit 32. Moreover, the air flowing out from the second outlet P2B flows in a direction away from the first inlet P1A. Accordingly, it is possible to prevent the refrigerant heated in the second cooling passage P2 and flowing out from the second outlet P2B from flowing into the first cooling passage P1 from the first inlet P1A, thereby preventing a decrease in the cooling efficiency of the first drive unit 31. Accordingly, the drive system 16 (the electric system) can efficiently cool the first drive unit 31 (the first electric device) and the second drive unit 32 (the second electric device).

The fan 33 includes a hub 61, a plurality of first blades 62, and a plurality of second blades 63 which are formed integrally with each other. The fan 33 can cause air to flow through the first cooling passage P1 and the second cooling passage P2 simply by rotating the hub 61 around the first direction X. This makes it easier to cool the first drive unit 31 and the second drive unit 32 by air.

The separation wall 71 separates the air blown by the first blades 62 and flowing out from the first outlet P1B from the air sucked in by the second blades 63 and flowing into the second inlet P2A. This more reliably prevents the air heated in the first cooling passage P1 and flowing out from the first outlet P1B from flowing into the second cooling passage P2 from the second inlet P2A, thereby preventing a decrease in the cooling efficiency of the second drive unit 32.

The separation duct 72 separates the air blown by the first blades 62 and flowing out from the first outlet P1B from the air sucked in by the second blades 63 and flowing into the second inlet P2A. This more reliably prevents the air heated in the first cooling passage P1 and flowing out from the first outlet P1B from flowing into the second cooling passage P2 from the second inlet P2A, thereby preventing a decrease in the cooling efficiency of the second drive unit 32.

Since the separation wall 71 and the hub 61 are not integrally formed, the separation wall 71 does not rotate around the first direction X even when the hub 61 (the shaft 35) rotates. Therefore, the drive system 16 does not consume power to rotate the separation wall 71, and the power consumption of the drive system 16 can be reduced more than in a case where the separation wall 71 and the hub 61 are formed integrally.

The propeller 36 is arranged at the first end 35A of the shaft 35 on the side of the second drive unit 32. As the propeller 36 rotates, a propulsive stream flowing along the first direction X is generated, and a portion of the propulsive stream easily flows into the first cooling passage P1 from the first inlet P1A. The air that has flowed through the second cooling passage P2 flows along the first direction X from the second outlet P2B together with the propulsive stream. Accordingly, the air that has flowed through the second cooling passage P2 easily flows out from the second outlet P2B. This suppresses a decrease in the flow rate of air flowing through the first cooling passage P1 due to the propulsive stream, and a decrease in the flow rate of air flowing through the second cooling passage P2 due to the propulsive stream. Accordingly, the drive system 16 can efficiently cool the first drive unit 31 and the second drive unit 32.

### Second embodiment

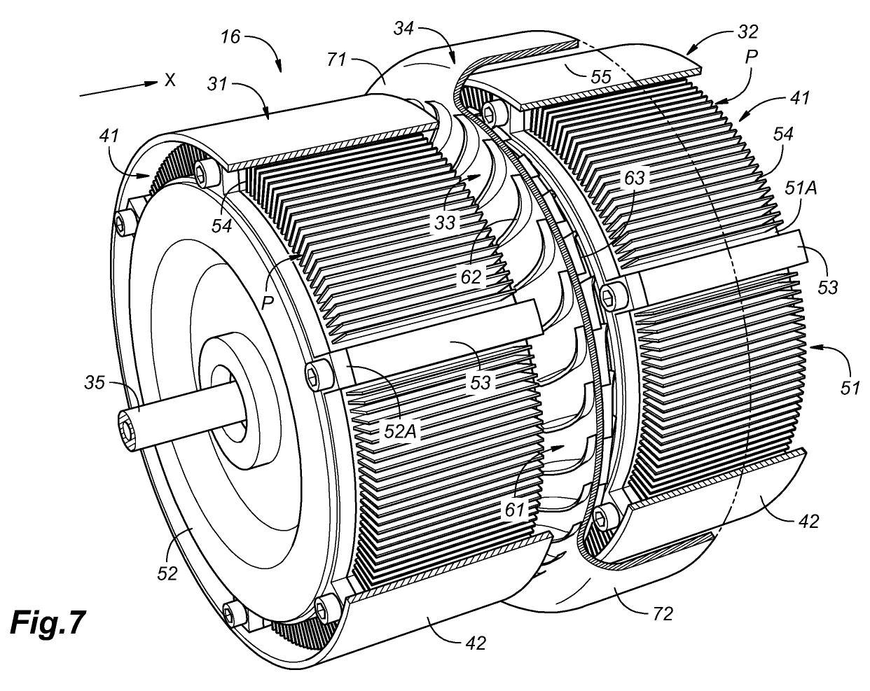

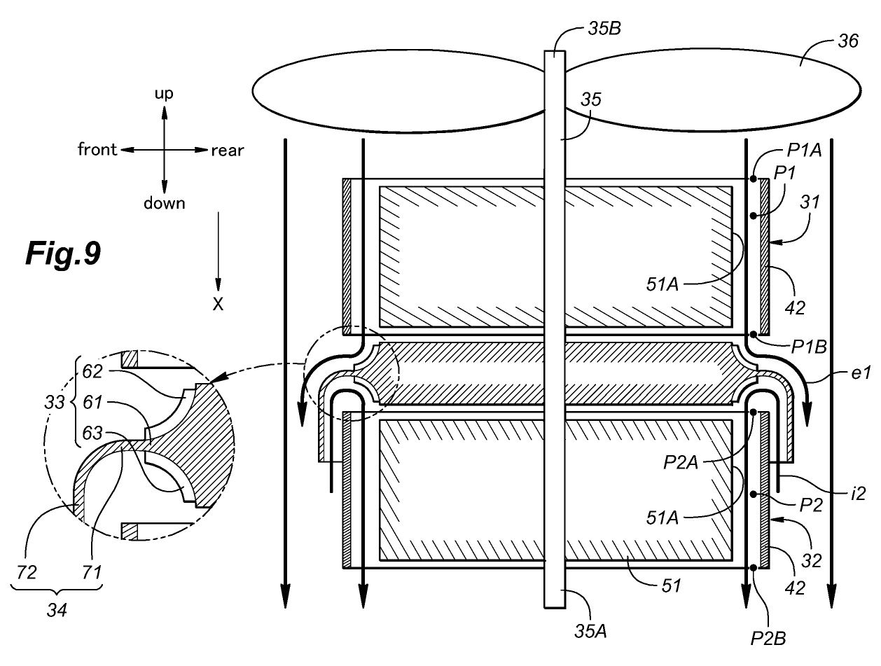

FIG. 7 is a perspective view of the drive system 16 according to the second embodiment. As shown in FIG. 7, the drive system 16 according to the second embodiment differs from the drive system 16 according to the first embodiment in the following three points: the separation wall 71 and the hub 61 are formed integrally; the propeller 36 is arranged at the second end 35B of the shaft 35 on the side of the first drive unit 31 (see FIG. 9); and the first direction X is oriented downward. In the following description according to the second embodiment, components that are the same as or similar to those according to the first embodiment are given the same reference numerals, and detailed descriptions thereof will be omitted.

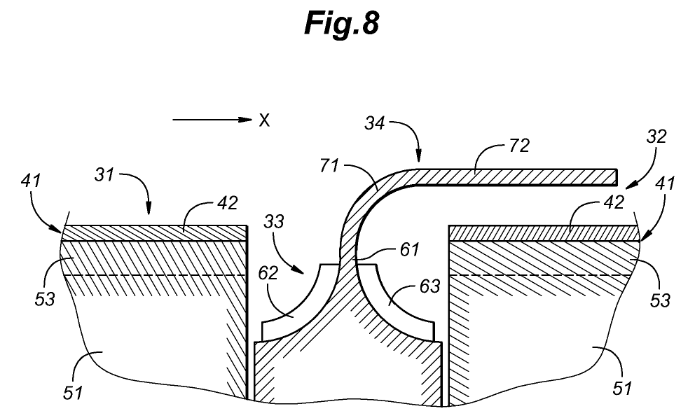

FIG. 8 is a cross-sectional view of the main part of the drive system 16. As shown in FIG. 8, the separation plate 34 includes the separation wall 71 and the separation duct 72 which are formed integrally with each other. The inner end of the separation wall 71 is integrated with the boundary between the first blades 62 and the second blades 63. Accordingly, the support member 55 is not provided in the drive system 16 according to the present embodiment. The separation plate 34 is supported by the hub 61. Since the separation wall 71 is formed integrally with the hub 61, the separation wall 71 can be easily provided. Further, the number of components can be reduced. This in turn makes it easier to provide the separation plate 34.

FIG. 9 is a schematic cross-sectional view of the drive system 16. In FIG. 9, the rear cover 37 and the front cover 38 are omitted. As shown in FIG. 9, in the drive system 16 according to the present embodiment, the propeller 36 generates the propulsive stream to apply the upward propulsion force to the aircraft 1.

As shown in FIG. 9, the propeller 36 is arranged at the second end 35B of the shaft 35 on the side of the first drive unit 31. As the propeller 36 rotates, a propulsive stream flowing along the first direction X is generated. Thus, a portion of the propulsive stream easily flows into the first cooling passage P1 from the first inlet P1A. The air that has flowed through the second cooling passage P2 flows along the first direction X from the second outlet P2B together with the propulsive stream. Accordingly, the air that has flowed through the second cooling passage P2 easily flows out from the second outlet P2B. This suppresses a decrease in the flow rate of air flowing through the first cooling passage P1 due to the propulsive stream, and also suppresses a decrease in the flow rate of air flowing through the second cooling passage P2 due to the propulsive stream. Accordingly, the drive system 16 can efficiently cool the first drive unit 31 and the second drive unit 32.

### First modification

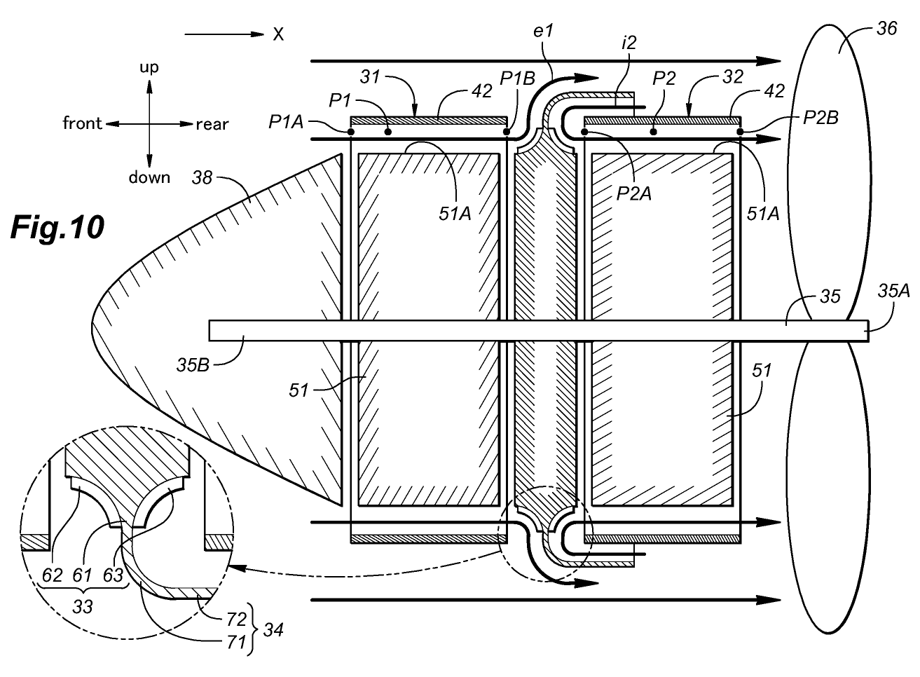

FIG. 10 is a schematic cross-sectional view of the drive system 16 according to the first modification. As shown in FIG. 10, the drive system 16 according to the first modification is the drive system 16 in which the separation wall 71 (the separation plate 34) and the hub 61 are formed integrally in the drive system 16 according to the first embodiment. That is, the drive system 16 according to the first modification is the drive system 16 in which the separation plate 34, the hub 61, and the support member 55 that fix the separation duct 72 to the duct 42 in the drive system 16 according to the first embodiment are replaced with the separation wall 71 (the separation plate 34) and the hub 61 that are formed integrally according to the second embodiment. As with the drive system 16 according to the first embodiment, in the drive system 16 according to the first modification, the flow direction (the first direction X) of the propulsive stream is oriented rearward.

### Second modification

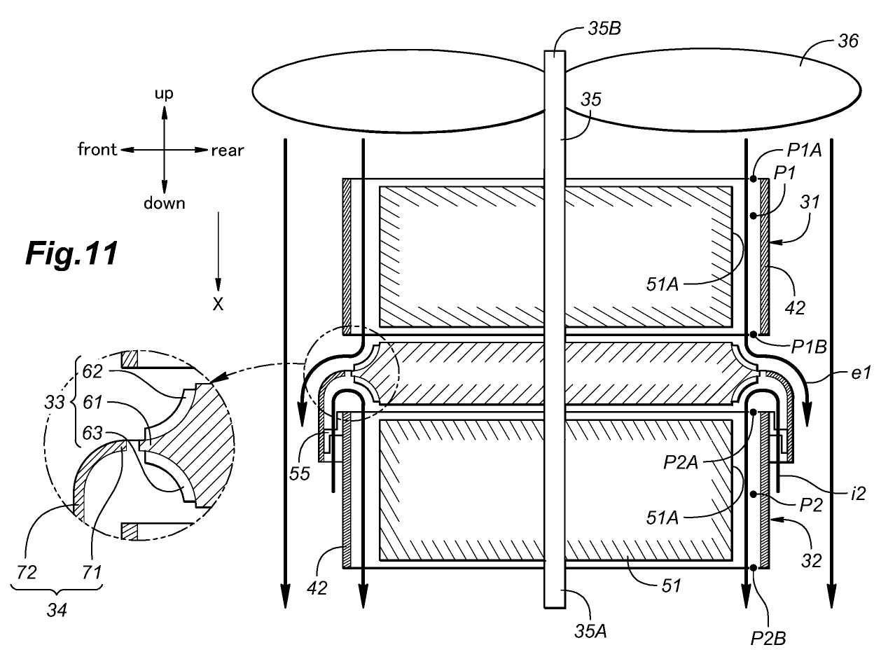

FIG. 11 is a schematic cross-sectional view of the drive system 16 according to the second modification. As shown in FIG. 11, the drive system 16 according to the second modification is the drive system 16 according to the second embodiment in which the separation wall 71 (the separation plate 34) and the hub 61 are not integrally formed. That is, the drive system 16 according to the second modification is the drive system 16 in which the integrally formed separation wall 71 (the separation plate 34) and the hub 61 in the drive system 16 according to the second embodiment are replaced with the separation plate 34, the hub 61, and the support member 55 that fix the separation duct 72 to the duct 42 according to the first embodiment. As with the drive system 16 according to the second embodiment, in the drive system 16 according to the second modification, the flow direction (the first direction X) of the propulsive stream is oriented downward.

Concrete embodiments of the present invention have been described in the foregoing, but the present invention should not be limited by the foregoing embodiments and various modifications and alterations are possible within the scope of the present invention. For example, in the drive system 16 according to the first embodiment and the drive system 16 according to the second embodiment, the drive system 16 may be supported to be able to change the flow direction of the propulsive stream. The drive system 16 may not necessarily include the shaft 35 and the propeller 36. In the first and second embodiments, air is used as the refrigerant, but the refrigerant may be any fluid. The refrigerant may be a gas or a liquid.

The drive system 16 according to the first embodiment and the second embodiment may not include the separation plate 34. The fan 33 may include a drive unit, and the hub 61 may be rotated by the drive unit. Further, in the drive system 16 according to the first and second embodiments, the separation duct 72 may be omitted from the separation plate 34. That is, the drive system 16 may include only the separation wall 71 instead of the separation plate 34. Further, the electric motor 41 may not be an inner rotor type three-phase AC motor.

1. A drive system comprising a first drive unit, a second drive unit, and a fan,
wherein the first drive unit, the fan, and the second drive unit are arranged in this order and in a row along a first direction from the first drive unit to the second drive unit,
the first drive unit includes a first cooling passage extending along the first direction and having a first inlet formed on a side opposite to the fan and a first outlet formed on a side of the fan,
the second drive unit includes a second cooling passage extending along the first direction and having a second inlet formed on the side of the fan and a second outlet formed on the side opposite to the fan, and
the fan is configured to:
suck in a refrigerant flowing out from the first outlet and blow the refrigerant in a direction intersecting the first direction, thereby causing the refrigerant to flow through the first cooling passage; and
suck in the refrigerant in the direction intersecting the first direction and blow the refrigerant toward the second inlet, thereby causing the refrigerant to flow through the second cooling passage.

2. The drive system according to claim 1, wherein the fan includes a hub, a plurality of first blades configured to suck in the refrigerant from the first outlet and blow the refrigerant in the direction intersecting the first direction, and a plurality of second blades configured to suck in the refrigerant in the direction intersecting the first direction and blow the refrigerant toward the second inlet, the hub, the plurality of first blades, and the plurality of second blades being integrally formed with each other.

3. The drive system according to claim 2, further comprising a separation wall one end of which is arranged to cover an outer circumference of a boundary between the plurality of first blades and the plurality of second blades, the separation wall extending radially outward relative to the hub from the one end and configured to separate the refrigerant blown by the plurality of first blades in the direction intersecting the first direction from the refrigerant sucked in by the plurality of second blades in the direction intersecting the first direction.

4. The drive system according to claim 3, comprising a separation duct formed integrally with the separation wall, extending from a radially outer end of the separation wall along the first direction, and covering an outer circumference of the second drive unit.

5. The drive system according to claim 3, wherein the separation wall is formed integrally with the hub.

6. The drive system according to claim 4, wherein the second drive unit includes a duct that defines the second cooling passage,
the one end of the separation wall is close to but spaced from the outer circumference of the boundary between the plurality of first blades and the plurality of second blades, and
the separation duct is attached to the duct.

7. The drive system according to claim 3, comprising:
a shaft supported by the first drive unit and the second drive unit to be rotatable around the first direction, coupled to the hub, and extending along the first direction; and
a propeller fixed to the shaft,
wherein the first drive unit and the second drive unit are configured to rotate the shaft around the first direction to generate a propulsive stream flowing along the first direction from the propeller,
the hub is configured to rotate around the first direction with the shaft, and
the propeller is arranged at a first end of the shaft on a side of the second drive unit.

8. The drive system according to claim 3, comprising:
a shaft supported by the first drive unit and the second drive unit to be rotatable around the first direction, coupled to the hub, and extending along the first direction; and
a propeller fixed to the shaft,
wherein the first drive unit and the second drive unit are configured to rotate the shaft around the first direction to generate a propulsive stream flowing along the first direction from the propeller,
the hub is configured to rotate around the first direction with the shaft, and
the propeller is arranged at a second end of the shaft on a side of the first drive unit.

9. An electric system comprising a first electric device, a second electric device, and a fan,
wherein the first electric device, the fan, and the second electric device are arranged in this order and in a row along a first direction from the first electric device to the second electric device,
the first electric device includes a first cooling passage extending along the first direction and having a first inlet formed on a side opposite to the fan and a first outlet formed on a side of the fan,
the second electric device includes a second cooling passage extending along the first direction and having a second inlet formed on the side of the fan and a second outlet formed on the side opposite to the fan, and
the fan is configured to:
suck in a refrigerant flowing out from the first outlet and blow the refrigerant in a direction intersecting the first direction, thereby causing the refrigerant to flow through the first cooling passage; and
suck in the refrigerant in the direction intersecting the first direction and blow the refrigerant toward the second inlet, thereby causing the refrigerant to flow through the second cooling passage.
